(19) United States
(12) Patent Application Publication
(10) Pub. No.: US 2002/0012041 A1
(43) Pub. Date: Jan. 31, 2002

(54) MULTI-BEAM SCANNING APPARATUS

(76) Inventors: SHIN MOGI, KASHIWA-SHI (JP); YASUTAKA NARUGE, TORIDE-SHI (JP)

Correspondence Address: FITZPATRICK CELLA HARPER & SCINTO, 30 ROCKEFELLER PLAZA, NEW YORK, NY, 10112, US

(21) Appl. No.: 09/392,626

(22) Filed: Sep. 9, 1999

(30) Foreign Application Priority Data
Sep. 14, 1998 (JP) 10-279352
Nov. 30, 1998 (JP) 10-355353

(51) Int. Cl. B41J 2/45

(52) U.S. Cl. 347/238

(57) ABSTRACT

A multi-beam scanning apparatus includes a multi-beam semiconductor laser which emits a plurality of laser beams, a laser holder holding the multi-beam semiconductor laser, a multi-beam light source unit having the multi-beam semiconductor laser and the laser holder, scanning imaging unit for scanning a plurality of laser beams emitted by the multi-beam semiconductor laser to form an image on a surface to be scanned, and a housing supporting the scanning imaging unit and the multi-beam light source unit. The multi-beam semiconductor laser is fixed to the laser holder with inclination at or near a predetermined rotational angle for adjusting a beam interval between the plurality of laser beams.

### BACKGROUND OF THE INVENTION

1. Field of the Invention

The present invention relates to a multi-beam scanning apparatus used for a laser beam printer, digital copying machine, and the like.

2. Related Background Art

In recent years, multi-beam scanning apparatuses for simultaneously writing a plurality of lines using a plurality of laser beams are being developed in electrophotographic apparatuses such as a laser beam printer.

The multi-beam scanning apparatus simultaneously scans a plurality of laser beams apart from each other. As shown in FIG. 1, in the multi-beam scanning apparatus, a multi-beam semiconductor laser 111 serving as a light source for a multi-beam light source unit 101 emits two laser beams P₁ and P₂. The laser beams P₁ and P₂ are collimated by a collimator lens 112, irradiate a reflecting surface 103a of a rotary polygon mirror 103 via a cylindrical lens 102, and form an image on a photosensitive member on a rotary drum 105 via an imaging lens 104.

The two laser beams P₁ and P₂ are incident on the reflecting surface 103a of the rotary polygon mirror 103, scanned in the main scanning direction, and form an electrostatic latent image on the photosensitive member along with main scanning by rotation of the rotary polygon mirror 103 and subscanning by rotation of the rotary drum 105.

The cylindrical lens 102 linearly focuses the laser beams P₁ and P₂ on the reflecting surface 103a of the rotary polygon mirror 103. The cylindrical lens 102 has a function of preventing a point image formed on the photosensitive member in the above manner from being distorted due to surface tilt of the rotary polygon mirror 103. The imaging lens 104 is made up of a spherical lens and toric lens. The imaging lens 104 has a function of preventing distortion of a point image on the photosensitive member, similar to the cylindrical lens 102, and a correction function of scanning the point image on the photosensitive member in the main scanning direction at a constant speed.

The two laser beams P₁ and P₂ are respectively split by a detection mirror 106 at the end of the main scanning plane (X-Y plane), guided to a photosensor 107 on an opposite side to the main scanning plane, and converted into write start signals in a controller (not shown) to be transmitted to the multi-beam semiconductor laser 111. The multi-beam semiconductor laser 111 receives the write start signals to start write modulation of the two laser beams P₁ and P₂.

By adjusting the write modulation timings of the two laser beams P₁ and P₂ , the write start (write) position of an electrostatic latent image formed on the photosensitive member on the rotary drum 105 is controlled.

The cylindrical lens 102, rotary polygon mirror 103, imaging lens 104, and the like are mounted on the bottom wall of an optical box 108. After the respective optical components are mounted in the optical box 108, the upper opening of the optical box 108 is closed with a lid (not shown).

As described above, the multi-beam semiconductor laser 111 simultaneously emits the laser beams P₁ and P₂. The multi-beam semiconductor laser 111 is integrated via a laser holder 111a with a lens barrel 112a incorporating the collimator lens 112, and the integral unit is mounted on a sidewall 108a of the optical box 108 together with a laser driving circuit board 113.

In mounting the multi-beam light source unit 101, the laser holder 111a holding the multi-beam semiconductor laser 111 is inserted into an opening 108b formed in the sidewall 108a of the optical box 108. The laser holder 111a is fitted in the lens barrel 112a of the collimator lens 112, the focal point and optical axis of the collimator lens 112 are adjusted, and the lens barrel 112a is adhered to the laser holder 111a. As shown in FIG. 2A, the laser holder 111a is rotated through a predetermined angle θ to adjust a straight line connecting the emission points of the laser beams P₁ and P₂ , i.e., the inclination angle of a laser array N. More specifically, as shown in FIG. 2B, the beam interval between the laser beams P₁ and P₂ emitted by the multi-beam semiconductor laser 111 is adjusted to make a pitch S between imaging points A₁ and A₂ on the rotary drum 105 in the main scanning direction, and a pitch, i.e., line interval T in the subscanning direction coincide with design values. After this adjustment, the laser holder 111a is fixed to the sidewall 108a of the optical box 108 with a screw or the like.

In the prior art, however, when the multi-beam light source unit is to be fixed to the optical box, the whole multi-beam light source unit is rotated through the predetermined angle θ together with the laser driving circuit board, thereby obtaining the line interval T. To realize this, a space enough to rotate the large-area laser driving circuit board must be prepared outside the optical box, which interferes with downsizing of the whole apparatus.

Further, an error allowable value for adjustment of the line interval T is as strict as several μm or less. If the angular adjustment range in assembling the multi-beam light source unit to the optical box is wide, high-precision adjustment is difficult to complete within a short time. The multi-beam light source unit cannot be assembled with high working efficiency and high reliability.

### SUMMARY OF THE INVENTION

The present invention has been made to eliminate the conventional drawbacks, and has as its object to provide a multi-beam scanning apparatus which can be downsized and allows adjusting the beam interval within a short time with high precision.

To achieve the above object, according to the present invention, there is provided a multi-beam scanning apparatus comprising a multi-beam light source unit having a multi-beam semiconductor laser and a laser holder holding the multi-beam semiconductor laser, scanning imaging means for scanning a plurality of laser beams emitted by the multi-beam semiconductor laser to form an image on a surface to be scanned, and a housing supporting the scanning imaging means and the multi-beam light source unit, wherein the multi-beam semiconductor laser is fixed to the laser holder with inclination at or near a predetermined rotational angle for adjusting a beam interval between the plurality of laser beams.

In the multi-beam scanning apparatus, the multi-beam semiconductor laser preferably has a laser array fixed with inclination with respect to a reference surface of the laser holder.

The multi-beam semiconductor laser preferably has a plurality of aligned emission points.

The multi-beam semiconductor laser preferably has a plurality of two-dimensionally arrayed emission points.

The laser holder is preferably integrated with a lens barrel holding a collimator lens.

In mounting the laser holder in the housing after the multi-beam semiconductor laser is fixed to the laser holder, the whole multi-beam light source unit is inclined (rotated) to adjust the beam interval. In this arrangement, however, angular adjustment is difficult to perform precisely, and spends a long time. In addition, an extra space is required to incline the large-area laser driving circuit board mounted on the multi-beam light source unit. To avoid this, in a unit assembly step of assembling the multi-beam semiconductor laser to the laser holder, the multi-beam semiconductor laser is rotated (inclined) through an angle necessary for adjusting the beam interval or an angle approximate to the necessary angle. In this state, the multi-beam semiconductor laser is fixed to the laser holder into a unit.

In mounting the multi-beam light source unit in the housing, the whole multi-beam light source unit is rotated through a small angle in order to finally adjust a small error arising from the component precision and the like.

Since final angular adjustment in mounting the multi-beam light source unit in the housing is done within a small angular range, the angle can be quickly adjusted with high precision.

Since the large-area laser driving circuit board need not be greatly inclined, the whole apparatus can be downsized.

The present invention has been made to eliminate the conventional drawbacks, and has as its object to provide a low-cost, high-performance multi-beam scanning apparatus which can easily ensure the installation positional precision of the multi-beam light source unit in terms of the structure, can improve the adjustment precision of the multi-beam line interval, can efficiently mount the multi-beam light source unit, and can maintain high image quality without generating any error upon mounting.

To achieve the above object, according to the present invention, there is provided a multi-beam scanning apparatus comprising a multi-beam light source unit having a multi-beam semiconductor laser and a laser holder holding the multi-beam semiconductor laser, scanning imaging means for scanning a plurality of laser beams emitted by the multi-beam semiconductor laser to form an image on a surface to be scanned, a housing supporting the scanning imaging means and the multi-beam light source unit, and fixing means for fixing the multi-beam light source unit to the housing after the rotational angle of the multi-beam light source unit is adjusted, the fixing means having a plurality of fixing portions, wherein the center of rotation of the multi-beam light source unit and a plurality of emission points of the multi-beam semiconductor laser are located on a straight line connecting two of the plurality of fixing portions or a planar region defined by straight lines connecting all the plurality of fixing portions.

The fixing means preferably has at least three fixing portions.

The fixing means preferably has a fixing portion fastened by a screw.

The fixing means preferably has a fixing portion adhered with an adhesive.

The multi-beam semiconductor laser preferably has a plurality of aligned emission points.

The multi-beam semiconductor laser preferably has a plurality of two-dimensionally arrayed emission points.

The laser holder is preferably integrated with a lens barrel holding a collimator lens.

In mounting the multi-beam semiconductor laser in the housing, the whole multi-beam light source unit is rotated to adjust the line interval. Thereafter, screws or the like are tightened to fix the multi-beam light source unit to the housing.

A plurality of fixing portions by screws or the like are set. The emission points of laser beams and the center of rotation of the multi-beam light source unit are located on a straight line connecting two of the fixing portions or a planar region defined by straight lines connecting all the fixing portions. Accordingly, the multi-beam light source unit can be very firmly, stably fixed to the housing.

Hence, no rotational shift occurs in the multi-beam light source unit due to shock or the like after the multi-beam light source unit is fixed to the housing.

Trouble such as a shift of the rotational angle of the multi-beam light source unit due to free running during screw tightening operation does not occur. Thus, the assembly efficiency and precision can be improved.

### BRIEF DESCRIPTION OF THE DRAWINGS

FIG. 1 is a schematic plan view showing a conventional multi-beam scanning apparatus;

FIGS. 2A and 2B are views for explaining line interval adjustment in the multi-beam scanning apparatus in FIG. 1;

FIG. 3 is a schematic plan view showing a multi-beam scanning apparatus according to the present invention;

FIG. 4 is an enlarged perspective view showing the first embodiment of a multi-beam light source unit in the multi-beam semiconductor laser of the apparatus in FIG. 3;

FIGS. 5A and 5B are views for explaining line interval adjustment;

FIG. 6 is a perspective view showing a laser holder temporarily fixed to an optical box;

FIG. 7 is a view for explaining final line interval adjustment;

FIG. 8 is a schematic view showing the second embodiment of the multi-beam light source unit;

FIG. 9 is a schematic view showing a multi-beam semiconductor laser in FIG. 8 together with a laser driving circuit board;

FIG. 10 is a schematic view showing the third embodiment of the multi-beam light source unit;

FIGS. 11A and 11B are views showing the fourth embodiment of the multi-beam light source unit, in which

FIG. 11A is a plan view showing the layout of three fixing portions, and

FIG. 11B is a sectional view showing the fixing portions; and

FIG. 12 is a schematic view showing the fifth embodiment of the multi-beam light source unit.

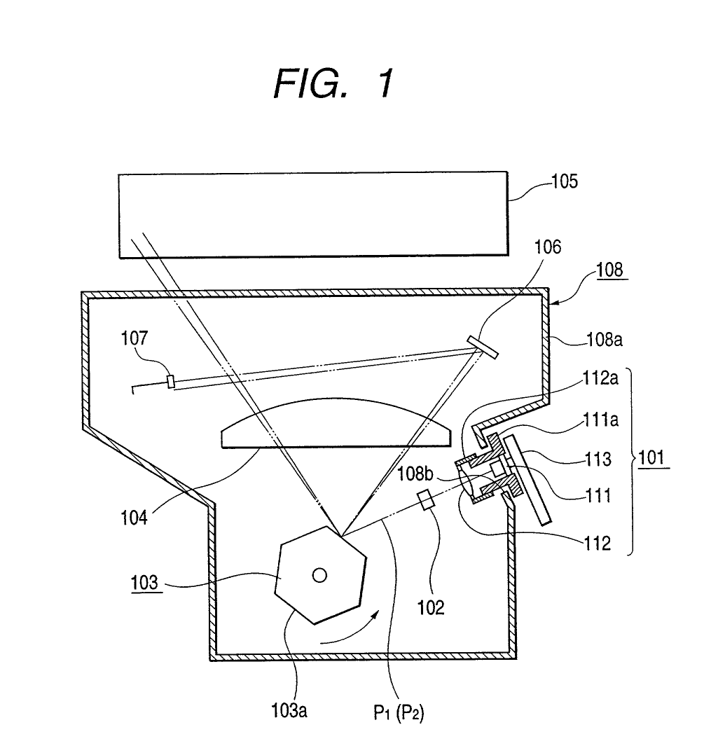

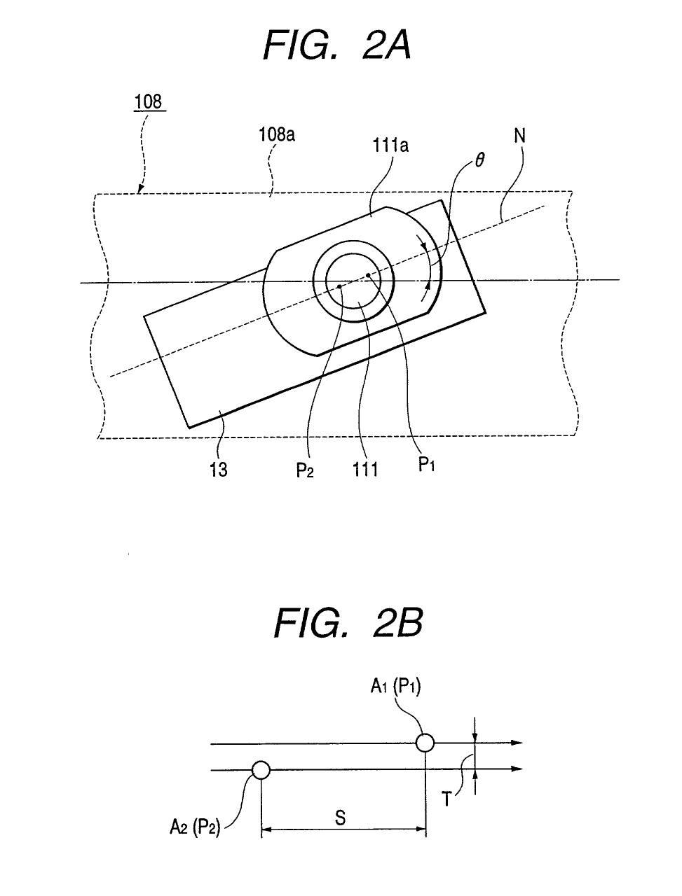

### DETAILED DESCRIPTION OF THE PREFERRED EMBODIMENTS

Embodiments of the present invention will be described below with reference to the accompanying drawings.

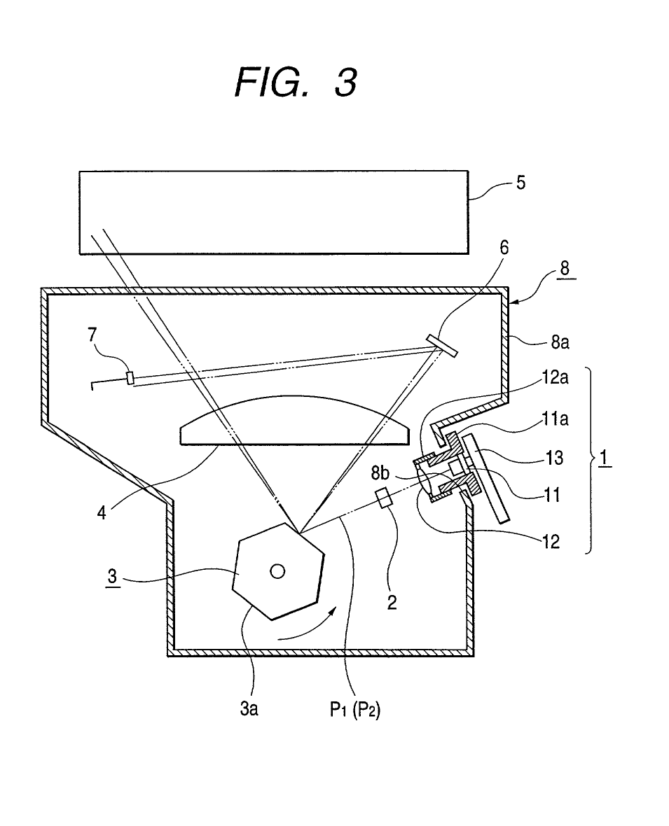

FIG. 3 shows a multi-beam scanning apparatus according to the present invention. In this multi-beam scanning apparatus, a multi-beam semiconductor laser 11 serving as a light source for a multi-beam light source unit 1 emits two laser beams P₁ and P₂. The laser beams P₁ and P₂ are collimated by a collimator lens 12, irradiate a reflecting surface 3a of a rotary polygon mirror 3 via a cylindrical lens 2, and form an image on a photosensitive member on a rotary drum 5 serving as a surface to be scanned via an imaging lens 4 which constitutes a scanning imaging means together with the rotary polygon mirror 3.

The two laser beams P₁ and P₂ are incident on the reflecting surface 3a of the rotary polygon mirror 3, scanned in the main scanning direction, and form an electrostatic latent image on the photosensitive member along with main scanning by rotation of the rotary polygon mirror 3 and subscanning by rotation of the rotary drum 5.

The cylindrical lens 2 linearly focuses the laser beams P₁ and P₂ on the reflecting surface 3a of the rotary polygon mirror 3. The cylindrical lens 2 has a function of preventing a point image formed on the photosensitive member in the above manner from being distorted due to surface tilt of the rotary polygon mirror 3. The imaging lens 4 is made up of a spherical lens and toric lens. The imaging lens 4 has a function of preventing distortion of a point image on the photosensitive member, similar to the cylindrical lens 2, and a correction function of scanning the point image on the photosensitive member in the main scanning direction at a constant speed.

The two laser beams P₁ and P₂ are respectively split by a detection mirror 6 at the end of the main scanning plane (X-Y plane), guided to a photosensor 7 on an opposite side to the main scanning plane, and converted into write start signals in a controller (not shown) to be transmitted to the multi-beam semiconductor laser 11. The multi-beam semiconductor laser 11 receives the write start signals to start write modulation of the two laser beams P₁ and P₂.

By adjusting the write modulation timings of the two laser beams P₁ and P₂, the write start (write) position of an electrostatic latent image formed on the photosensitive member on the rotary drum 5 is controlled.

The cylindrical lens 2, rotary polygon mirror 3, imaging lens 4, and the like are mounted on the bottom wall of an optical box 8 serving as a housing. After the respective optical components are mounted in the optical box 8, the upper opening of the optical box 8 is closed with a lid (not shown).

As described above, the multi-beam semiconductor laser 11 simultaneously emits the laser beams P₁ and P₂. The multi-beam semiconductor laser 11 is integrated via a laser holder 11a with a lens barrel 12a incorporating the collimator lens 12, and the integral unit is mounted on a sidewall 8a of the optical box 8 together with a laser driving circuit board 13.

In mounting the multi-beam light source unit 1, the laser holder 11a holding the multi-beam semiconductor laser 11 is inserted into an opening 8b formed in the sidewall 8a of the optical box 8. The laser holder 11a is fitted in the lens barrel 12a of the collimator lens 12, three-dimensional adjustment such as focus adjustment and optical axis adjustment of the collimator lens 12 is done, and the lens barrel 12a is adhered to the laser holder 11a.

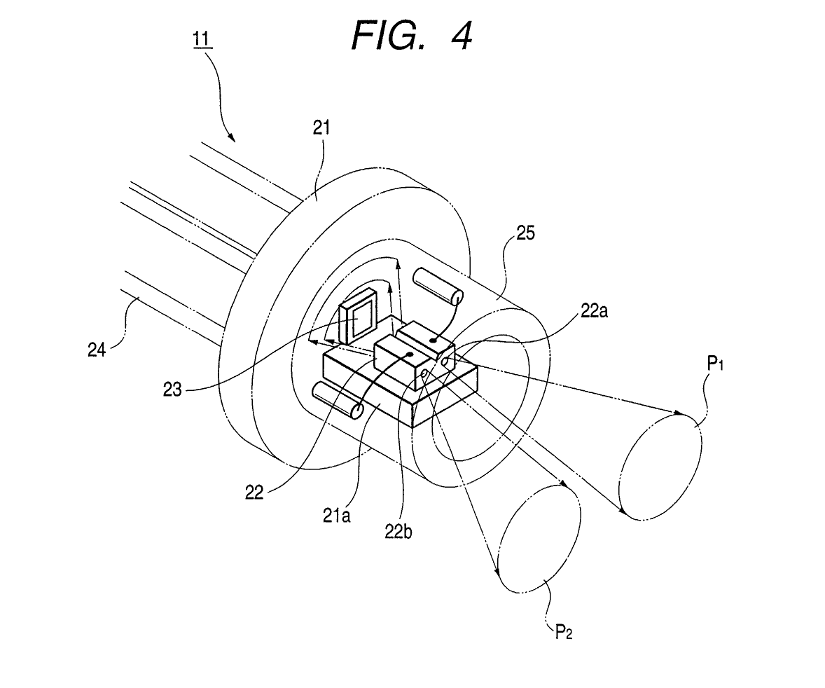

As shown in FIG. 4, the multi-beam semiconductor laser 11 comprises a laser chip 22 fixed to a pedestal 21a integrated with a stem 21, a photodiode 23 for monitoring the emission amounts of laser beams P₁ and P₂ emitted from two emission points 22a and 22b on the laser chip 22, and an enerigization terminal 24 for energizing the laser chip 22 and the like. The laser chip 22 and the like are covered with a cap 25.

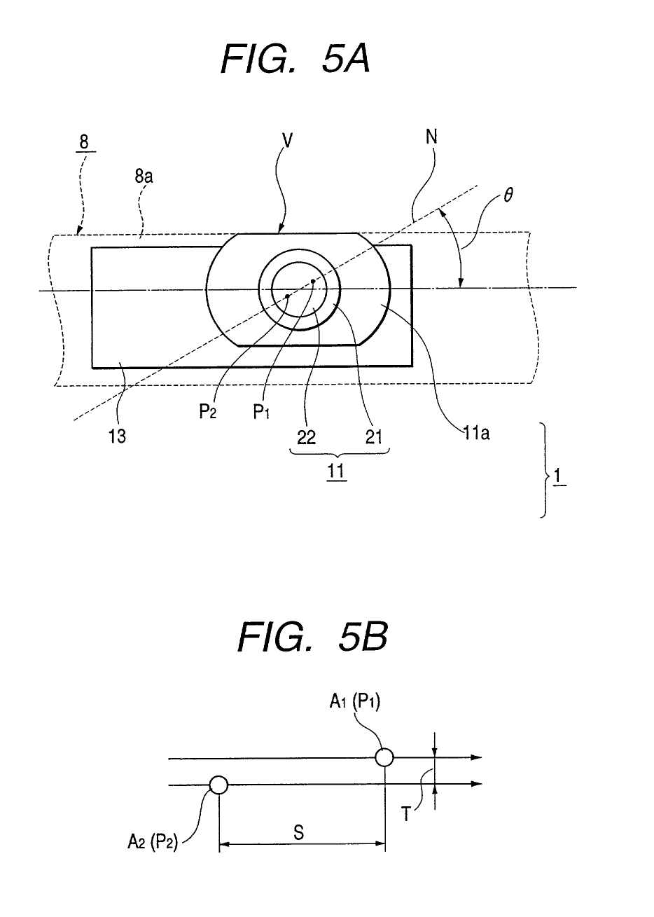

In a unit assembly step of mounting the multi-beam semiconductor laser 11 in the laser holder 11a, the multi-beam semiconductor laser 11 is rotated through a predetermined rotational angle θ or angle approximate to the angle θ with respect to a reference surface V of the laser holder 11a, as shown in FIG. 5A, thereby adjusting in advance the inclination angle of a straight line, i.e., laser array N connecting the emission points of the laser beams P₁ and P₂. More specifically, the beam interval between the laser beams P₁ and P₂ emitted by the multi-beam semiconductor laser 11 is adjusted to make a pitch S between imaging points A₁ and A₂ on the rotary drum 5 in the main scanning direction, and a pitch, i.e., line interval T in the subscanning direction coincide with design values in advance (see FIG. 5B). After this adjustment, the multi-beam semiconductor laser 11 is fixed to the laser holder 11a to obtain a unit.

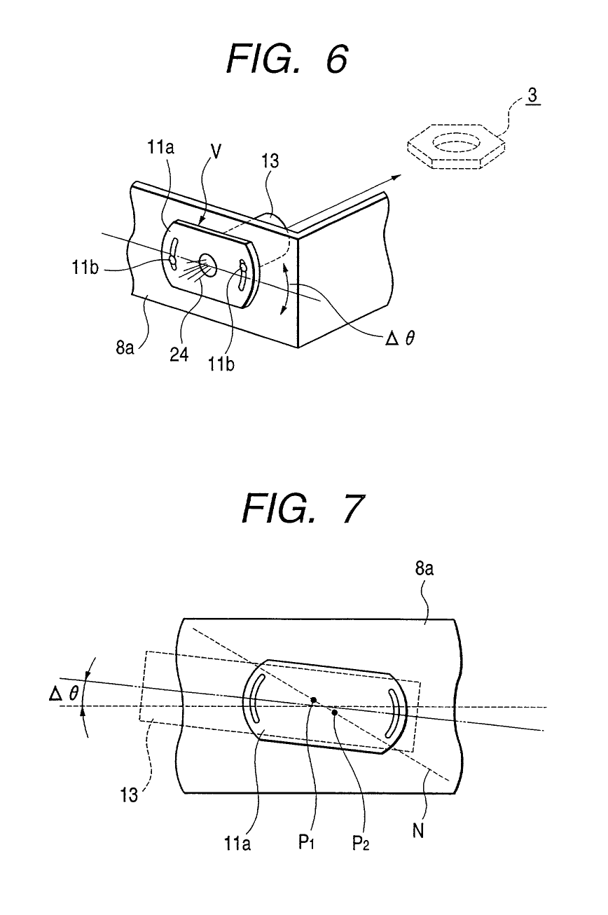

After the lens barrel 12a of the collimator lens 12 is adhered to the laser holder 11a, as described above, the laser holder 11a is temporarily fixed to the sidewall 8a of the optical box 8 with screws 11b fitted in slots of the laser holder 11a, as shown in FIG. 6. While emitting the laser beams P₁ and P₂, the laser holder 11a is rotated through a small angle Δθ for final adjustment of the line interval T in order to compensate for the precision of each apparatus component and an error at the fit portion of the multi-beam semiconductor laser 11 itself. In practice, as indicated by the broken line in FIG. 7, this adjustment is done after the laser driving circuit board 13 is mounted on the laser holder 11a. Upon the final adjustment, the screws 11b are tightened to fix the laser holder 11a to the optical box 8.

The line interval T on the rotary drum must be adjusted with submicron-order precision. In the first embodiment, when the multi-beam semiconductor laser is mounted in the laser holder, the laser array N is roughly adjusted to or near to the predetermined inclination angle θ. When the laser holder is mounted in the optical box together with the laser driving circuit board, the angle is finally slightly adjusted to correct an assembly error and the like. Therefore, the final line interval adjustment precision is very high, and the adjustment time can be greatly shortened compared to the conventional wide-range angular adjustment on the optical box. In addition, the large-area laser driving circuit board need not be rotated outside the optical box, and the apparatus can be downsized.

As a result, this embodiment can realize a small-size, high-precision multi-beam scanning apparatus with low assembly cost.

Note that this embodiment uses the laser chip with two emission points. However, the number of emission points, i.e., laser beams can be arbitrarily changed. The assembly procedure of the laser driving circuit board, lens barrel, collimator lens, and the like can also be arbitrarily changed. The laser holder can be fixed to the optical box not only with a fastening means such as a screw, but also by another method such as adhesion.

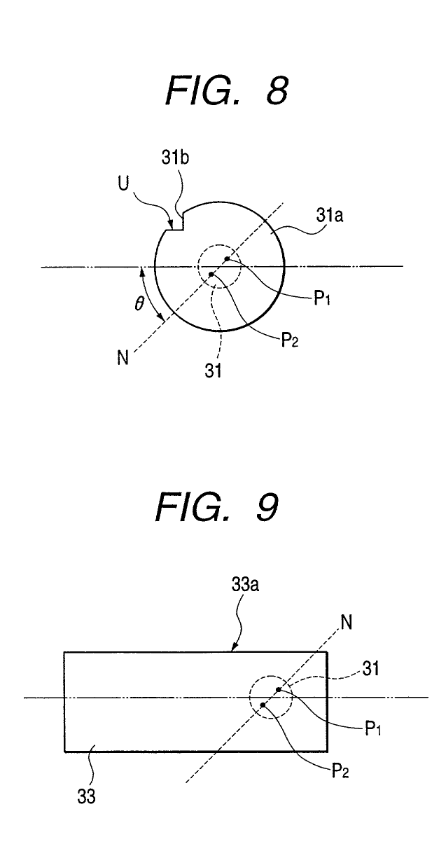

FIG. 8 shows the second embodiment of the multi-beam light source unit. This multi-beam light source unit uses a disk-like laser holder 31a instead of the rectangular laser holder 11a having a reference surface V as an end face. In this case, a reference surface U with a rotational angle θ in mounting a multi-beam semiconductor laser 31 in the laser holder 31a is defined at a notched portion 31b at the circumferential portion of the laser holder 31a.

As shown in FIG. 9, a laser driving circuit board 33 is mounted on the laser holder 31a such that an upper end face 33a serves as an attachment reference for an optical box (not shown).

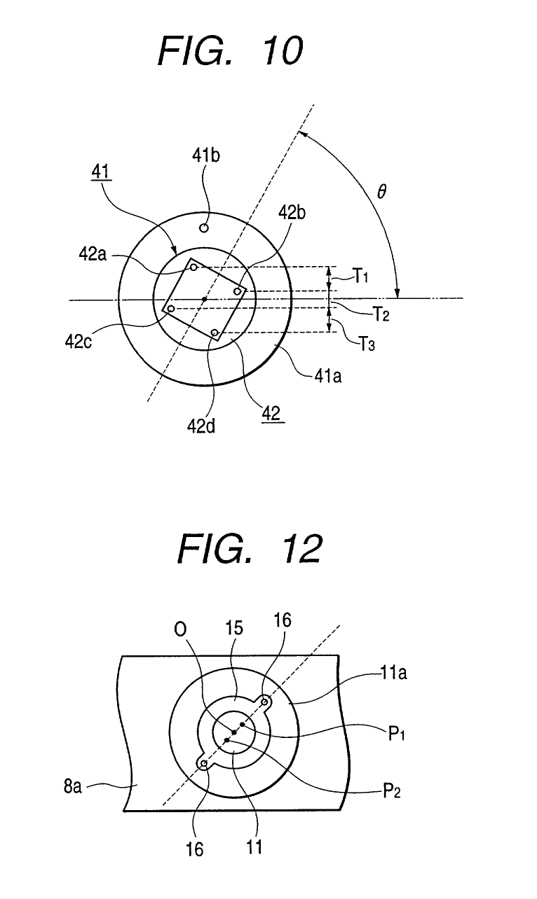

The edge emission type multi-beam semiconductor lasers 11 and 31 on each of which a plurality of emission points are aligned may be replaced with a multi-beam semiconductor laser 41 having a surface emission type laser chip 42 on which a plurality of emission points 42a to 42d are two-dimensionally arrayed, as shown in FIG. 10. This multi-beam semiconductor laser 41 can advantageously reduce optical aberration because all the emission points can be made close to the optical axis of the collimator lens. A positioning hole 41b is formed in a disk-like laser holder 41a as a positioning reference used to adjust the rotational angle θ for adjusting beam intervals T₁ to T₃.

The surface emission type laser can increase the degree of freedom for the positions of the emission points to facilitate distribution of the mounting tolerance.

As described above, in the multi-beam scanning apparatus of the present invention, the two laser beams P₁ and P₂ emitted by the multi-beam semiconductor laser 11 are scanned by the rotary polygon mirror inside the optical box 8, and form an image on the photosensitive member on the rotary drum via the imaging lens. To adjust the line interval T and the like on the photosensitive member, when the multi-beam semiconductor laser 11 is to be mounted in the laser holder 11a, the multi-beam semiconductor laser 11 is rotated to incline the laser array N at the predetermined inclination angle θ. Then, the multi-beam semiconductor laser 11 is fixed to the laser holder 11a. In mounting the multi-beam light source unit 1 in the optical box 8, the whole multi-beam light source unit 1 is only slightly inclined to compensate for the component precision and the like.

With this arrangement, the present invention exhibits the following effects.

The beam interval between a plurality of laser beams emitted by the multi-beam semiconductor laser can be adjusted within a short time with high precision. Accordingly, the apparatus can attain high resolution, the assembly cost can be greatly reduced, and the whole apparatus can be downsized.

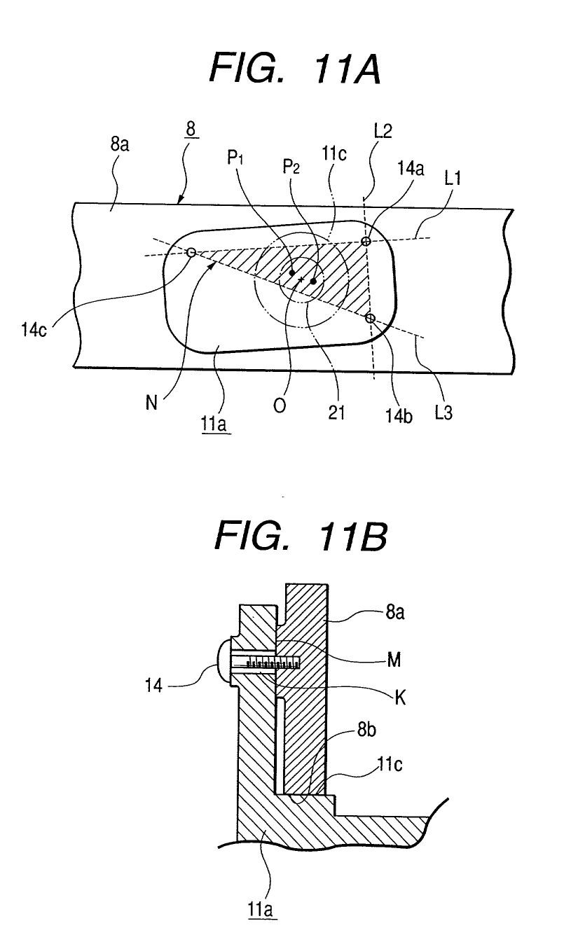

The fourth embodiment of the present invention will be described below. FIGS. 11A and 11B are schematic views showing the fourth embodiment of the multi-beam light source unit. The whole arrangement of the multi-beam scanning apparatus is the same as that shown in FIG. 3, and a description thereof will be omitted. The multi-beam light source unit will be explained.

As shown in FIGS. 11A and 11B, after a lens barrel 12a of a collimator lens 12 is adhered to a laser holder 11a, the laser holder 11a is temporarily fixed to a sidewall 8a of an optical box 8 with screws 14 (see FIGS. 11A and 11B) serving as fixing means fitted in holes in the laser holder 11a. While emitting laser beams P₁ and P₂, the laser holder 11a is rotated to adjust the inclination angle θ in order to adjust the line interval T, as shown in FIG. 5A.

This adjustment is to adjust the beam interval between the two laser beams P₁ and P₂ emitted by the multi-beam semiconductor laser 11, i.e., to make the pitch S between imaging points A₁ and A₂ on a rotary drum 5 in the main scanning direction, and a pitch, i.e., line interval T in the subscanning direction coincide with design values.

After the angular adjustment, the screws 14 are tightened to fix the laser holder 11a to the optical box 8.

In this adjustment, the laser holder 11a is rotated while the spot positions, i.e., imaging points A₁ and A₂ of the two laser beams P₁ and P₂ that displace in submicron order are monitored with a CCD camera or the like.

As shown in FIG. 11A, the three screws 14 fasten the laser holder 11a to the sidewall 8a of the optical box 8. Fixing portions 14a to 14c by the screws 14 surround the emission points of the laser beams P₁ and P₂. That is, the three screws 14 are laid out to locate the emission points of the laser beams P₁ and P₂ on straight lines L₁ to L₃ connecting the fixing portions 14a to 14c or within a planar region N (shadow portion) defined by the straight lines L₁ to L₃.

The laser holder 11a has a cylindrical boss 11c. As shown in FIG. 11B, the boss 11c is fitted in a cylindrical opening 8b in the sidewall 8a of the optical box 8 so as to rotate the laser holder 11a. The center O of rotation is also positioned on the straight lines L₁ to L₃ connecting the fixing portions 14a to 14c or within the planar region N defined by the straight lines L₁ to L₃.

With this layout, the emission points of the two laser beams P₁ and P₂ always fall within the range defined by lengths obtained by converting the intervals between the fixing portions 14a to 14c into main scanning and subscanning components. The wide range including the center O of rotation can be firmly fixed to effectively prevent vertical and horizontal tilt of the multi-beam light source unit 1.

Particularly when the screws 14 are used as fixing means, the laser holder 11a and the sidewall 8a of the optical box 8 are pressed against each other via a fastening surface M. A clearance K is set as an adjustment margin for angular adjustment rotation. The laser holder 11a is moved within this range.

The fastening surface M at the fixing portions 14a to 14c of the screws 14 provides the highest fastening reliability and high stability because the laser holder 11a and sidewall 8a contact each other at fastening pressure generation positions. Note that if the fastening surface M does not completely coincide with the positions of the screws 14, the same effects can be obtained so long as they are close to each other. The position and shape of the fastening surface M and the number of fastening surfaces M need not be limited.

The fourth embodiment adopts the screws as fixing means, but may adopt an adhesion means with an ultraviolet-curing adhesive or the like. The number of emission points is not limited and may be arbitrarily set to two or more.

The collimator lens is adhered to the lens barrel preferably with the ultraviolet-curing adhesive, but may be adhered with another adhesive.

According to the fourth embodiment, the multi-beam light source unit is fastened to the sidewall of the optical box with screws at three or more fixing portions. The center of rotation of the multi-beam light source unit and the emission points of respective laser beams locate on straight lines connecting the fixing portions or within the planar region defined by straight lines connecting all the fixing portions. Thus, the multi-beam light source unit can be stably, firmly mounted in the optical box.

The fourth embodiment can realize a low-cost, high-performance multi-beam scanning apparatus capable of effectively avoiding troubles such as a rotational shift of the multi-beam light source unit upon high-precision line interval adjustment, and free running during fastening upon adjustment.

FIG. 12 shows the fifth embodiment of the multi-beam light source unit. When the position of the emission point of a multi-beam semiconductor laser 11 greatly offsets from the center O of rotation of a laser holder 11a due to low component precision, the multi-beam semiconductor laser 11 is adjusted again in the laser holder 11a. To realize this, an adjustment member 15 for adjusting the relative position is used and fastened to the laser holder 11a with screws 16.

The adjustment member 15 is relatively moved together with the multi-beam semiconductor laser 11 with respect to the laser holder 11a to adjust a laser array connecting laser beams P₁ and P₂ so as to pass through the center O of rotation. Then, the adjustment member 15 is fastened to the laser holder 11a with the screws 16.

Even if the positional precision of emission points varies in the component, the adjustment member 15 can adjust the positions of the emission points to locate them on straight lines L₁ to L₃ connecting fixing portions 14a to 14c or within the planar region N defined by all the straight lines L₁ to L₃, as shown in FIG. 11A.

The package shape of the multi-beam semiconductor laser can advantageously be selected from a wide range.

The edge emission type multi-beam semiconductor laser 11 on which a plurality of emission points are aligned may be replaced with a multi-beam semiconductor laser 41 having a surface emission type laser chip 42 on which a plurality of emission points 42a to 42d are two-dimensionally arrayed, as shown in FIG. 10. This multi-beam semiconductor laser 41 can advantageously reduce optical aberration because all the emission points can be made close to the optical axis of the collimator lens. A positioning hole 41b is formed in a disk-like laser holder 41a as a positioning reference used to adjust the inclination angle θ for adjusting line intervals T₁ to T₃.

The surface emission type laser can increase the degree of freedom for the positions of the emission points to facilitate distribution of the mounting tolerance.

As described above, in the multi-beam scanning apparatus of the present invention, the two laser beams P₁ and P₂ emitted by the multi-beam semiconductor laser are scanned by the rotary polygon mirror inside the optical box 8, and form an image on the photosensitive member on the rotary drum via the imaging lens. To adjust the line interval and the like on the photosensitive member, the laser holder 11a is fixed to the sidewall 8a of the optical box 8 after rotation through a predetermined angle. The fixing portions 14a to 14c are set to locate the emission points of the laser beams P₁ and P₂ and the center O of rotation on straight lines connecting the fixing portions 14a to 14c by the screws 14 or within the planar region N defined by these lines. The laser holder 11a is firmly, stably mounted with high positional precision.

With this arrangement, the present invention exhibits the following effects.

The line interval between a plurality of laser beams emitted by the multi-beam semiconductor laser can be adjusted with high precision, and the laser holder can be firmly, stably mounted.

The present invention can realize a low-cost, high-performance multi-beam scanning apparatus free from any multi-beam line interval error.

What is claimed is:

1. A multi-beam scanning apparatus comprising:
a multi-beam semiconductor laser;
a laser holder holding said multi-beam semiconductor laser;
a multi-beam light source unit having said multi-beam semiconductor laser and said laser holder;
scanning imaging means for scanning a plurality of laser beams emitted by said multi-beam semiconductor laser to form an image on a surface to be scanned; and
a housing supporting said scanning imaging means and said multi-beam light source unit,
wherein said multi-beam semiconductor laser is fixed to said laser holder with inclination at or near a predetermined rotational angle for adjusting a beam interval between the plurality of laser beams.

2. An apparatus according to claim 1, wherein said multi-beam semiconductor laser has a laser array fixed with inclination with respect to a reference surface of said laser holder.

3. An apparatus according to claim 1, wherein said multi-beam semiconductor laser has a plurality of aligned emission points.

4. An apparatus according to claim 1, wherein said multi-beam semiconductor laser has a plurality of two-dimensionally arrayed emission points.

5. An apparatus according to claim 1, wherein said laser holder is integrated with a lens barrel holding a collimator lens.

6. A multi-beam light source unit comprising:
a multi-beam semiconductor laser for emitting a plurality of laser beams;
a laser holder holding said multi-beam semiconductor laser; and
a multi-beam light source unit having said multi-beam semiconductor laser and said laser holder,
wherein said multi-beam semiconductor laser is fixed to said laser holder with inclination at or near a predetermined rotational angle for adjusting a beam interval between the plurality of laser beams.

7. A unit according to claim 6, wherein said multi-beam semiconductor laser has a laser array fixed with inclination with respect to a reference surface of said laser holder.

8. A unit according to claim 6, wherein said multi-beam semiconductor laser has a plurality of aligned emission points.

9. A unit according to claim 6, wherein said multi-beam semiconductor laser has a plurality of two-dimensionally arrayed emission points.

10. A unit according to claim 6, wherein said laser holder is integrated with a lens barrel holding a collimator lens.

11. A multi-beam scanning apparatus comprising:
a multi-beam semiconductor laser;
a laser holder holding said multi-beam semiconductor laser;
a multi-beam light source unit having said multi-beam semiconductor laser and said laser holder;
scanning imaging means for scanning a plurality of laser beams emitted by said multi-beam semiconductor laser to form an image on a surface to be scanned;
a housing supporting said scanning imaging means and said multi-beam light source unit; and
fixing means for fixing said multi-beam light source unit to said housing, said fixing means having a plurality of fixing portions,
wherein the center of rotation of said multi-beam light source unit and a plurality of emission points of said multi-beam semiconductor laser are located on a straight line connecting at least two of the plurality of fixing portions or a planar region defined by straight lines connecting all the plurality of fixing portions.

12. An apparatus according to claim 11, wherein said fixing means has at least three fixing portions.

13. An apparatus according to claim 11, wherein said fixing means has a fixing portion fastened by a screw.

14. An apparatus according to claim 11, wherein said fixing means has a fixing portion adhered with an adhesive.

15. An apparatus according to claim 11, wherein said multi-beam semiconductor laser has a plurality of aligned emission points.

16. An apparatus according to claim 11, wherein said multi-beam semiconductor laser has a plurality of two-dimensionally arrayed emission points.

17. An apparatus according to claim 11, wherein said laser holder comprises an adjustment member for adjusting a relative position of said multi-beam semiconductor laser.

18. An apparatus according to claim 11, wherein said laser holder is integrated with a lens barrel holding a collimator lens.

19. A multi-beam light source unit comprising:
a multi-beam semiconductor laser for emitting a plurality of laser beams;
a laser holder holding said multi-beam semiconductor laser;
a multi-beam light source unit having said multi-beam semiconductor laser and said laser holder;
a housing supporting said multi-beam light source unit; and
fixing means for fixing said multi-beam light source unit to said housing, said fixing means having a plurality of fixing portions,
wherein the center of rotation of said multi-beam light source unit and a plurality of emission points of said multi-beam semiconductor laser are located on a straight line connecting at least two of the plurality of fixing portions or a planar region defined by straight lines connecting all the plurality of fixing portions.

20. A unit according to claim 19, wherein said fixing means has at least three fixing portions.

21. A unit according to claim 19, wherein said fixing means has a fixing portion fastened by a screw.

22. A unit according to claim 19, wherein said fixing means has a fixing portion adhered with an adhesive.

23. A unit according to claim 19, wherein said multi-beam semiconductor laser has a plurality of aligned emission points.

24. A unit according to claim 19, wherein said multi-beam semiconductor laser has a plurality of two-dimensionally arrayed emission points.

25. A unit according to claim 19, wherein said laser holder comprises an adjustment member for adjusting a relative position of said multi-beam semiconductor laser.

26. A unit according to claim 19, wherein said laser holder is integrated with a lens barrel holding a collimator lens.
